(19) United States
(12) Patent Application Publication
(10) Pub. No.: US 2024/0391734 A1
(43) Pub. Date: Nov. 28, 2024

(54) ELEVATOR SYSTEM

(71) Applicant: KONE Corporation, Helsinki (FI)

(72) Inventors: Tommi HUOTARI, Helsinki (FI); Juha PARVIAINEN, Helsinki (FI)

(73) Assignee: KONE Corporation, Helsinki (FI)

(21) Appl. No.: 18/791,083

(22) Filed: Jul. 31, 2024

Related U.S. Application Data
(63) Continuation of application No. PCT/EP2022/058587, filed on Mar. 31, 2022.

(51) Int. Cl. B66B 1/46; B66B 1/34; B66B 5/00; F21V 23/04

(52) U.S. Cl. CPC B66B 1/46; B66B 1/3446; B66B 5/0025; F21V 23/0435

(57) ABSTRACT

According to an aspect, there is provided an elevator system. The system includes at least one light arranged in an elevator shaft; and a light switch associated with the at least one light and configured to operate a state of the at least one light, wherein the at least one light is configured to be remotely controllable.

### TECHNICAL FIELD

The present application relates to the field of elevator systems.

### BACKGROUND

In elevator systems, an elevator car moves in an elevator shaft. Some elements associated with the elevator system may be accessible only by accessing the elevator shaft, for example, during maintenance or cleaning. Due to this, one or more lights are needed in the elevator shaft in order to provide visibility and safety to a maintenance person. A light switch controlling the lights may be located, for example, in an elevator machine room, an elevator control cabinet or the elevator shaft itself.

Sometimes the maintenance or cleaning person may forget to turn off the elevator shaft lights, when the site visit is over. This may then lead, for example, to another visit in order to switch off the lights.

### SUMMARY

According to an aspect, there is provided an elevator system comprising at least one light arranged in an elevator shaft, and a light switch associated with the at least one light and configured to operate a state of the at least one light, wherein the at least one light is configured to be remotely operated switch.

In an implementation form, the light switch comprises a remotely operated switch configured to remotely control the state of the light switch.

In an implementation form, the elevator system further comprises at least one remotely operated switch comprising a first remotely operated switch arranged in series with the light switch to enable switching off the at least one light irrespective of the state of the light switch.

In an implementation form, the at least one remotely operated switch comprises a second remotely operated switch arranged in parallel with the light switch and the first remotely operated switch to enable switching on the at least one light irrespective of the state of the light switch.

In an implementation form, the at least one remotely operated switch comprises a second remotely operated switch arranged in parallel with the light switch and wherein the first remotely operated switch is connected in series with the parallelly connected light switch and second remotely operated switch to enable switching on the at least one light irrespective of the state of the light switch.

In an implementation form, the at least remotely operated switch is connected to an elevator communication network of the elevator system.

In an implementation form, the elevator communication network comprises an Ethernet-based communication network.

In an implementation form, the elevator system further comprises a controller configured to control the at least remotely operated switch.

In an implementation form, the controller is configured to detect the state of the light switch, and when detecting a use of the light switch, the controller is configured to control the at least one remotely operated switch so that the light switch has a control over the at least one light.

In an implementation form, the controller is configured to detect the state of the light switch, and to transmit the state of the light switch to a remote node.

In an implementation form, the controller is configured to transmit the state of the light switch to the remote node after an expiration of a preset time when the at least one light is on.

In an implementation form, the controller is configured to transmit the state of the light switch to the remote node when an operation mode of an elevator has changed from a maintenance state to a normal state and the at least one light is on.

In an implementation form, the controller is configured to transmit the state of the light switch to the remote node, when an operation mode of an elevator has changed from a maintenance state to a normal state and the at least one light is on and a preset time has passed after the operation mode change.

In an implementation form, the controller is configured to receive, from the remote node, an instruction to switch off the at least one light, and to control at least one of the at least one remotely operated switch to switch off the at least one light.

In an implementation form, the remote node comprises an internal node of the elevator system, a node external to the elevator system, a cloud node, a building management system node, or a remote service center node.

In an implementation form, the controller is configured to detect an operation mode change of an elevator from a maintenance state to a normal state, and to control the at least one remotely operated switch to switch the at least one light off in response to detecting the operation mode change from the maintenance state to the normal state.

In an implementation form, the controller is configured to detect an operation mode change of an elevator from a maintenance state to a normal state, and to control the at least one remotely operated switch to switch the at least one light off in response to detecting the operation mode change from the maintenance state to the normal state and when a preset time has passed after the operation mode change.

In an implementation form, the elevator system further comprises alerting means, wherein the controller is configured to initiate an alert with the alerting means, when detecting an operation mode change of an elevator from a maintenance state to a normal state and the at least one light is on.

In an implementation form, the light switch is located in an elevator machine room, a shaft electrification panel or a maintenance access panel.

In an implementation form, the controller comprises an elevator controller or an elevator group controller.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A illustrates a lighting arrangement in an elevator shaft of an elevator system according to an example embodiment.

FIG. 1B illustrates a lighting arrangement in an elevator shaft of an elevator system according to another example embodiment.

FIG. 1C illustrates a lighting arrangement in an elevator shaft of an elevator system according to another example embodiment.

FIG. 1D illustrates a lighting arrangement in an elevator shaft of an elevator system according to another example embodiment.

FIG. 2A illustrates an elevator system according to an example embodiment.

FIG. 2B illustrates an elevator system according to another example embodiment.

FIG. 3 illustrates an elevator system according to another example embodiment.

### DETAILED DESCRIPTION

The following description illustrates an elevator system that comprises at least one light arranged in an elevator shaft, and a light switch associated with the at least one light and configured to operate a state of the at least one light, wherein the at least one light is configured to be remotely operated switch. The illustrated solution may enable, for example, a solution in which the lights in the elevator shaft can be remotely switched off, even in a case in which a maintenance or cleaning person left the lights on when leaving the elevator shaft.

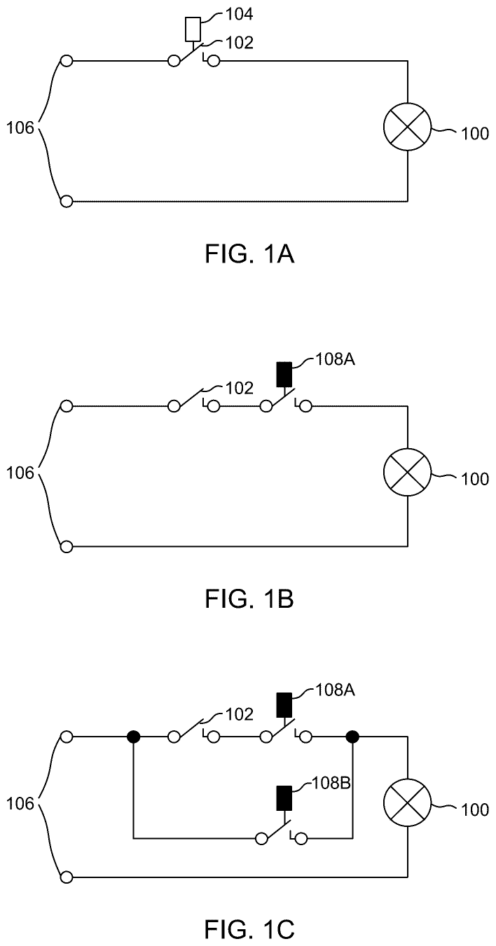

FIG. 1A illustrates an elevator system according to an example embodiment. The elevator system comprises at least one light 100 configured to light up an elevator shaft, for example during a maintenance or cleaning visit. A light switch 102 associated with the at least one light is configured to operate a state of the at least one light. The light switch 102 may be located, for example, in an elevator machine room, a shaft electrification panel or a maintenance access panel. Operating power for the at least one light 100 may be obtained from a power source 106.

It may happen that, when a maintenance or cleaning person leaves the elevator shaft or site, he/she may forget to switch off the at least one light 100 from the elevator shaft. In order to enable a remote operation for switching the lights off, the light switch 102 may comprise a remotely operated switch 104 configured to remotely control the state of the light switch 102. This enables, for example, a solution in which the at least one light can be switched remotely off and no extra site visit is needed in order to switch the at least one light 100 off.

FIG. 1B illustrates an elevator system according to another example embodiment. The elevator system comprises at least one light 100 configured to light up an elevator shaft, for example during a maintenance or cleaning visit. A light switch 102 associated with the at least one light 100 is configured to operate a state of the at least one light 100. The light switch 102 may be located, for example, in an elevator machine room, a shaft electrification panel or a maintenance access panel. Operating power for the at least one light 100 may be obtained from a power source 106.

It may happen that, when a maintenance or cleaning person leaves the elevator shaft or site, he/she may forget to switch off the at least one light 100 from the elevator shaft. In order to enable a remote operation for switching the lights off, a remotely operated switch 108A may be arranged in series with the light switch 102 to enable switching off the at least one light 100 irrespective of the state of the light switch 102. In other words, even if the light switch 102 has switched the at least one light 100 on, the remotely operated switch 108A may be controlled to open the circuit between the light switch 102 and the at least one light 100, thus switching off the at least one light 100. This enables, for example, a solution in which the at least one light can be switched remotely off and no extra site visit is needed in order to switch the at least one light 100 off.

FIG. 1C illustrates an elevator system according to another example embodiment. The solution disclosed in FIG. 1C is similar to the one disclosed in FIG. 1B with the exception that there is also a second remotely operated switch 108B arranged in parallel with the light switch 102 and the remotely operated switch 108A to enable switching on the at least one light 100 irrespective of the state of the light switch 102. In other words, when the light switch 102 is in off state, the at least one light 100 can still be switched on by the remote operated switch 108B as it bypasses the serially connected light switch 102 and the remote operated switch 108A.

FIG. 1D illustrates an elevator system according to another example embodiment. The solution disclosed in FIG. 1D is similar to the one disclosed in FIG. 1C with the exception that in FIG. 1D the second remotely operated switch 108B has been arranged in parallel only with the light switch 102, and the remotely operated switch 108A is connected in series with the parallelly connected light switch 102 and second remotely operated switch 108B.

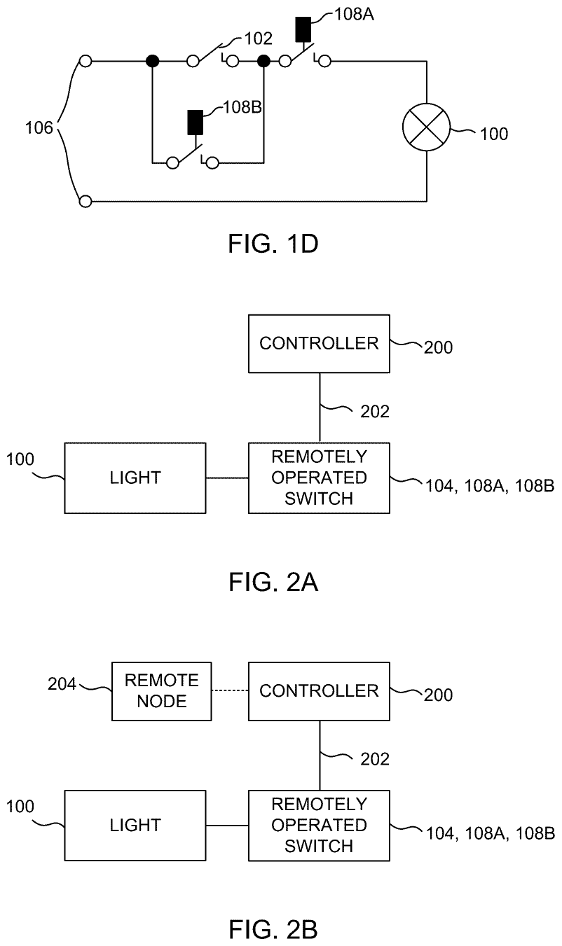

FIG. 2A illustrates an elevator system according to an example embodiment. The elevator system comprises a controller 200, for example, an elevator controller or an elevator group controller, configured to control various operations relating to the elevator system. The controller 200 may be communicatively connected to at least one remotely operated switch 104, 108A, 108B. The communication link 202 between the controller 200 and the at least one remotely operated switch 104, 108A, 108B may be implemented, for example, by using Ethernet-based communication. As an example, the at least one remotely operated switch 104, 108A, 108B may be a node connected to a point-to-point ethernet bus, for example, a 100BASE-TX or a 10BASET1L point-to-point ethernet bus, or to a multi-drop ethernet bus, for example, a 10BASE-T1S multi-drop ethernet bus. The controller 200 may be configured to control a state of the at least one remotely operated switch 104, 108A, 108B via the communication link 202, as discussed already with respect to FIGS. 1A-1D.

FIG. 2B illustrates an elevator system according to another example embodiment. The embodiment illustrated in FIG. 2B is identical with the embodiment illustrated in FIG. 2A with the exception that the controller 200 may be communicatively connected to a remote node 204. The remote node 204 may be an internal node of the elevator system or a node external to the elevator system. In an example embodiment, the remote node 204 may be a cloud node, a building management system (BMS) node, a remote service center node etc. The controller 200 may receive a remote instruction from the remote node 204 and control the at least one remotely operated switch 104, 108A, 108B based on the remote instruction.

In an example embodiment of any of FIGS. 1A-1D, 2A and FIG. 2B, the controller 200 may be configured to detect the state of the light switch 102, and when detecting a use of the light switch 102, the controller 200 may be configured to control the at least one remotely operated switch 104, 108A, 108B so that the light switch 102 has a control over the at least one light 100. This may happen, for example, when maintenance or cleaning is performed in the elevator shaft. When a maintenance or cleaning person is on-site and switches the lights 100 on via the light switch 102, this may be detected by the controller 200. In response to this, the controller 200 may verify that the remotely operated switches 104, 108A, 108B do not prohibit the correct functioning of the lights 100. In the example illustrated in FIG. 1B, this would mean setting the remotely operated switch 108A to a conducting state. In the example illustrated in FIG. 1C, this would mean setting the remotely operated switch 108A to a conducting state and the remotely operated switch 108B to a non-conducting state.

In an example embodiment of any of FIGS. 1A-1D and FIG. 2B, the controller 200 may be configured to detect the state of the light switch 102, and to transmit the state of the light switch 102 to the remote node 204, for example, to a cloud node, a building management system (BMS) node, a remote service center node etc. In another example embodiment, the controller 200 may be configured to transmit the state of the light switch 102 to the remote node 204 after an expiration of a preset time when the at least one light 100 is still on. The remote node 204 may then further use this information. For example, if it is detected that at least one light 100 is still on even if maintenance or cleaning has already been performed, the remote node 204 may send a message to the person involved in the maintenance/cleaning about the situation.

In an example embodiment of any of FIGS. 1A-1D and FIG. 2B, the controller 200 may be configured to transmit the state of the light switch 102 to the remote node 204 when an operation mode of an elevator has changed from a maintenance state to a normal state and the at least one light 100 is on. In another example embodiment, the controller 200 may be configured to transmit the state of the light switch 102 to the remote node 204, when an operation mode of an elevator has changed from a maintenance state to a normal state and the at least one light 100 is on and a preset time has passed after the operation mode change. The operation mode may be changed, for example, from a maintenance access panel or with an emergency opening device of landing floor doors. The change in the operation mode may be interpreted so that the maintenance/cleaning has ended, but the involved person forgot to switch the at least one light 100 off. Further, the controller 200 may be configured to receive, from the remote node 204, an instruction to switch off the at least one light 100, and to control at least one of the at least one remotely operated switch 104, 108A, 108B to switch off the at least one light 100.

In an example embodiment of any of FIGS. 1A-1D, FIG. 2A and FIG. 2B, the controller 200 may be configured to act independent without any additional instructions from the remote node 204 to switch off the at least one light 100. In an example embodiment, the controller 200 may be configured to detect an operation mode change of an elevator from a maintenance state to a normal state, and to control the at least one remotely operated switch 104, 108A, 108B to switch the at least one light 100 off in response to detecting the operation mode change from the maintenance state to the normal state. In another example embodiment, the controller 200 may be configured to detect an operation mode change of an elevator from a maintenance state to a normal state, and to control the at least one remotely operated switch 104, 108A, 108B to switch the at least one light 100 off in response to detecting the operation mode change from the maintenance state to the normal state and when a preset time has passed after the operation mode change. In addition to the operation mode change, the controller 200 may have also detected that a safety circuit indicates that all the doors at floor levels are in a locked state. When additionally using a timer, further assurance is obtained that the maintenance/cleaning person has finished the maintenance/cleaning.

In an example embodiment of any of FIGS. 1A-1D, FIG. 2A and FIG. 2B, the system may further comprise alerting means, and the controller 200 may be configured to initiate an alert with the alerting means, when detecting an operation mode change of an elevator from a maintenance state to a normal state and the at least one light 100 is on. The alerting means may provide at least one of a visual alert or a sound alert to notify a maintenance/cleaning person about the situation.

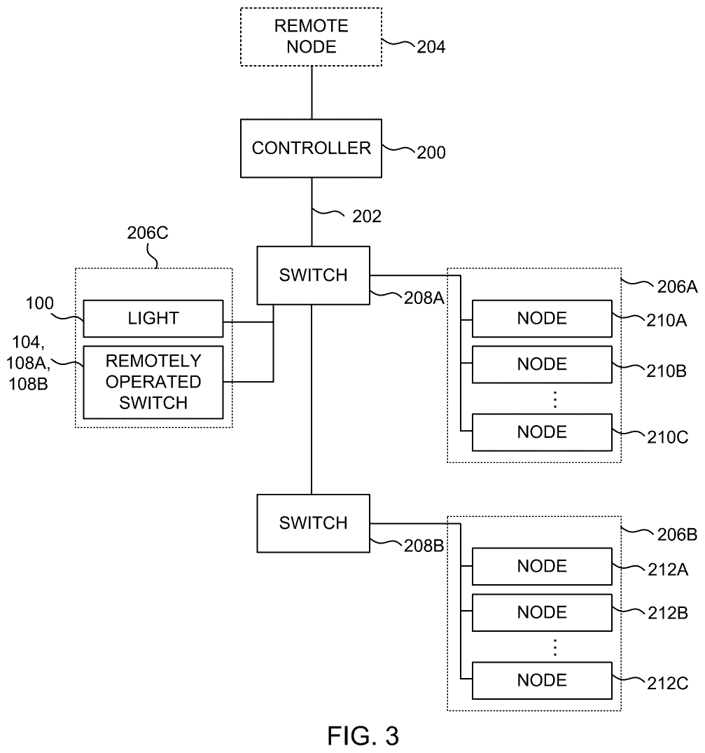

FIG. 3 illustrates an elevator system according to another example embodiment. The elevator system comprises an elevator communication system comprising an elevator communication network configured to carry elevator system associated data. The elevator communication network may be an ethernet-based communication network and it may comprise at least one point-to-point ethernet bus 202 and/or at least one multi-drop ethernet segment 206A, 206B, 206C. The point-to-point ethernet bus may be, for example, a 100BASE-TX or a 10BASET1L point-to-point ethernet bus. The multi-drop ethernet bus segments may comprise, for example, a 10BASE-T1S multi-drop ethernet bus.

In an example embodiment, the elevator communication system may comprise at least one connecting unit 208A, 208B comprising a first port connected to the respective multi-drop ethernet bus segments 206A, 206B, 206C and a second port connected to the point-to-point ethernet bus 202. Thus, by using the connecting units 208A, 208B, one or more multi-drop ethernet bus segments 206A, 206B, 206C may be connected to the point-to-point ethernet bus 202. The connecting unit 208A, 208B may refer, for example, to a switch.

The elevator communication system may comprise one or more multi-drop ethernet bus segments 206A, 206B, 206C (for example, in the form of 10BASE-T1S) reachable by the elevator controller 200, and a plurality of elevator system nodes 100, 104, 108A, 108B, 210A-210C, 212A-212C coupled to the multi-drop ethernet bus segments 206A, 206B, 206C and configured to communicate via the multi-drop ethernet bus segments 206A, 206B, 206C. The elevator controller 100 is reachable by the elevator system nodes 100, 104, 108A, 108B, 210A-210C, 212A-212C via the multi-drop ethernet bus segments 206A, 206B, 206C. Elevator system nodes that are coupled to the same multi-drop ethernet bus segment may be configured so that one elevator system node is to be active at a time while the other elevator system nodes of the same multi-drop ethernet bus segment are in a high-impedance state.

In an example embodiment, an elevator system node 210A-210C, 212A-212C may be configured to interface with at least one of an elevator fixture, an elevator sensor, an elevator safety device, audio means (for example, a microphone and/or a loudspeaker), a camera and an elevator control device. Further, in an example embodiment, power to the nodes may be provided with the same cabling.

By implementing communication within the elevator communication system using at least one point-to-point ethernet bus and at least one multi-drop ethernet bus segment, various segments can be formed within the elevator communication system. For example, the elevator system nodes 210A-210C may form a first landing segment 206A, the elevator system nodes 212A-212c may form a second landing segment 206B, and the light 100 and the remotely operated switch(es) 104, 108A, 108B may form an elevator shaft lighting segment 206C.

The controller 200 may comprise at least one processor. The controller 200 may further comprise at least one memory. The memory may comprise program code which, when executed by the processor causes the controller to perform at least one example embodiment discussed herein. The exemplary embodiments and aspects of the subject-matter can be included within any suitable device, for example, including, a server, an elevator controller, an elevator group controller, a workstation, capable of performing the processes of the exemplary embodiments. The exemplary embodiments may also store information relating to various processes described herein. Although the controller 200 is illustrated as a single device it is appreciated that, wherever applicable, functions of the controller 200 may be distributed to a plurality of devices.

Example embodiments may be implemented in software, hardware, application logic or a combination of software, hardware and application logic. The example embodiments can store information relating to various methods or steps described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods or steps described with respect to the example embodiments can include appropriate data structures for storing data collected and/or generated by the methods of the devices and subsystems of the example embodiments in one or more databases.

The processor may comprise one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments may be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

The controller 200 may comprise a communication interface configured to enable the controller to transmit and/or receive information, to/from other apparatuses.

While there have been shown and described and pointed out fundamental novel features as applied to preferred embodiments thereof, it will be understood that various omissions and substitutions and changes in the form and details of the devices and methods described may be made by those skilled in the art without departing from the scope of the claims. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the claims.

1. An elevator system comprising:
at least one light arranged in an elevator shaft; and
a light switch associated with the at least one light and configured to operate a state of the at least one light,
wherein the at least one light is configured to be remotely controllable.

2. The elevator system of claim 1, wherein the light switch comprises a remotely operated switch configured to remotely control the state of the light switch.

3. The elevator system of claim 1, further comprising at least one remotely operated switch comprising a first remotely operated switch arranged in series with the light switch to enable switching off the at least one light irrespective of the state of the light switch.

4. The elevator system of claim 3, wherein the at least one remotely operated switch comprises a second remotely operated switch arranged in parallel with the light switch and the first remotely operated switch to enable switching on the at least one light irrespective of the state of the light switch.

5. The elevator system of claim 3, wherein the at least one remotely operated switch comprises a second remotely operated switch arranged in parallel with the light switch and wherein the first remotely operated switch is connected in series with the parallelly connected light switch and second remotely operated switch to enable switching on the at least one light irrespective of the state of the light switch.

6. The elevator system of claim 1, wherein the at least remotely operated switch is connected to an elevator communication network of the elevator system.

7. The elevator system of claim 6, wherein the elevator communication network comprises an Ethernet-based communication network.

8. The elevator system of claim 1, further comprising a controller configured to control the at least remotely operated switch.

9. The elevator system of claim 8, wherein the controller is configured to detect the state of the light switch, and when detecting a use of the light switch, the controller is configured to control the at least one remotely operated switch so that the light switch has a control over the at least one light.

10. The elevator system of claim 8, wherein the controller is configured to detect the state of the light switch, and to transmit the state of the light switch to a remote node.

11. The elevator system of claim 10, wherein the controller is configured to transmit the state of the light switch to the remote node after an expiration of a preset time when the at least one light is on.

12. The elevator system of claim 10, wherein the controller is configured to transmit the state of the light switch to the remote node when an operation mode of an elevator has changed from a maintenance state to a normal state and the at least one light is on.

13. The elevator system of claim 10, wherein the controller is configured to transmit the state of the light switch to the remote node, when an operation mode of an elevator has changed from a maintenance state to a normal state and the at least one light is on and a preset time has passed after the operation mode change.

14. The elevator system of claim 10, wherein the controller is configured to receive, from the remote node, an instruction to switch off the at least one light, and to control at least one of the at least one remotely operated switch to switch off the at least one light.

15. The elevator system of claim 10, wherein the remote node comprises an internal node of the elevator system, a node external to the elevator system, a cloud node, a building management system node, or a remote service center node.

16. The elevator system of claim 8, wherein the controller is configured to detect an operation mode change of an elevator from a maintenance state to a normal state, and to control the at least one remotely operated switch to switch the at least one light off in response to detecting the operation mode change from the maintenance state to the normal state.

17. The elevator system of claim 8, wherein the controller is configured to detect an operation mode change of an elevator from a maintenance state to a normal state, and to control the at least one remotely operated switch to switch the at least one light off in response to detecting the operation mode change from the maintenance state to the normal state and when a preset time has passed after the operation mode change.

18. The elevator system of claim 8, further comprising alerting means, wherein the controller is configured to initiate an alert with the alerting means, when detecting an operation mode change of an elevator from a maintenance state to a normal state and the at least one light is on.

19. The elevator system of claim 1, wherein the light switch is located in an elevator machine room, a shaft electrification panel or a maintenance access panel.

20. The elevator system of claim 1, wherein the controller comprises an elevator controller or an elevator group controller.
